(19) United States
(12) Patent Application Publication
(10) Pub. No.: US 2019/0197635 A1
(43) Pub. Date: Jun. 27, 2019

(54) Eleutheria (Freedom), Digital Cryptocurrency for Virtual Electricity Trading Platform

(71) Applicant: TAESUNG KIM, Lake Forest, IL (US)

(72) Inventor: TAESUNG KIM, Lake Forest, IL (US)

(21) Appl. No.: 16/214,670

(22) Filed: Dec. 10, 2018

Related U.S. Application Data
(60) Provisional application No. 62/610,043, filed on Dec. 22, 2017.

(51) Int. Cl. G06Q 50/06; G06Q 20/06; G06Q 40/04

(52) U.S. Cl. CPC G06Q 50/06; G06Q 2220/00; G06Q 40/04; G06Q 20/065

(57) ABSTRACT

This invention describes a new digital cryptocurrency—named Eleutheria throughout this patent—that can be used within a virtual electricity trading platform to virtually transact real and digital currencies, smart contracts, financial derivatives, and electricity based on Distributed Electricity Generation (“DG”) plants using Distributed Energy Resources (“DERs”) and Energy Storage Systems (“ESS”) by utilizing new technologies including Internet of Things (IoT). Information and Communication Technology (ICT), Artificial Intelligence (AI), and Smart Grid. Eleutheria is composed of four basic and two derivative cryptocurrencies: (i) ψ₁(k,t)-Cryptocurrency to transact “Currency Exchange” in a designated country and time; (ii) ψ₂(k,t)-Cryptocurrency to transact “Smart Contracts” in a designated country and time; (iii) ψ₃(k,t)-Cryptocurrency to transact “Financial Derivatives” in a designated country and time ; (iv) ψ₄(k,t)-Cryptocurrency to transact “Electricity” in a designated country and time; (v) ψ_{own}(k,t)-Cryptocurrency to transact “Ownership of DG plants” in a designated country and time; (vi) ψₑₗₑᵤₜₕₑᵣᵢₐ(k,t)-Cryptocurrency, Eleutheria represents a portfolio of cryptocurrencies, ψᵢ and is expressed as ψₑₗₑᵤₜₕₑᵣᵢₐ(k,t)=ψ₀+Σβᵢ(k,t)×χᵢ(k,t)×ψᵢ(k,t), where i=1, 2, 3, 4, and own (ownership). Then a risk premium fᵢ(R:k,t) based on a risk assessment matrix of Eleutheria is incorporated to express a cryptocurrency as ψ₁(k,t)=ψ₀[1+fᵢ(R:k,t)].

### BACKGROUND

### Field of the Invention

This invention describes a new digital cryptocurrency—named Eleuthetia throughout this patent—that can be used within a virtual electricity trading platform to virtually transact real and digital currencies, smart contracts, financial derivatives, and electricity based on DG plants using DERs and ESS by exploiting new technologies within IoT, ICT, AI, and Smart Grid. This new digital cryptocurrency is composed of four basic and two derivative cryptocurrencies as below:
ψ₁(k,t): Cryptocurrency to transact “Currency Exchange” in a designated country and time
ψ₂(k,t): Cryptocurrency to transact “Smart Contract” in a designated country and time
ψ₃(k,t): Cryptocurrency to transact “Financial Derivatives” In a designated country and time
ψ₄(k,t): Cryptocurrency to transact “Electricity” in a designated country and time
ψ_{own}(k,t): Cryptocurrency to transact “Ownership of DG plants” in a designated country and time
ψₑₗₑᵤₜₕₑᵣᵢₐ(k,t): Cryptocurrency, Eleutheria represents a portfolio of cryptocurrencies, ψᵢ owned by a certain participant

where k: Geographic coordinate of a designated DERs project location
t: Remaining time to a designated transaction=t_{f}−tₒ
t_{f}: Designated transaction time in the future
tₒ: Present
i=1, 2, 3, 4, and own
   This new digital cryptocurrency can be represented as a portfolio of each cryptocurrency, Eleutheria-ψₑₗₑᵤₜₕₑᵣᵢₐ as below:

ψₑₗₑᵤₜₕₑᵣᵢₐ(k,t)=ψ₀+Σβᵢ(k,t)×χᵢ(k,t)×ψᵢ(k,t)

where ψ₀: Present value of USD in USA
βᵢ(k,t) Percentage of ψᵢ in a portfolio
χᵢ(k,t): Correlation coefficient between Eleutheria and each currency
i=1, 2, 3, 4, and own
   This new digital cryptocurrency includes a risk premium to compensate for risk by using the below risk matrix:

$$\begin{matrix}{f}_{i} ( R \text{:} k , t ) = Risks involved in Risk Assessment Matrix of \\ Eleutheria - Risk Free Return \\ = {α}_{i} ( k , t ) \times {f}_{i} ( S \text{:} k , t ) \times {f}_{i} ( P \text{:} k , t ) \times {f}_{i} ( D \text{:} k , t ) - {f}_{o} ( k , t )\end{matrix}$$

where fᵢ(R:k,t): Risk premium due to risks involved in each currency of Eleutheria
αᵢ(k,t): Correlation coefficient of Risk Premium from peer-to-peer trading
fᵢ(S:k,t): Degree of Severity from each risk
fᵢ(P:k,t): Probability of Occurrence of each risk
fᵢ(D:k,t): Detection capability of each risk
fₒ(k,t): Risk free return factor
   Further, this new digital cryptocurrency expresses value of each cryptocurrency as below:

ψᵢ(k,t)=ψ₀[1+fᵢ(R:k,t)]

### DESCRIPTION OF THE RELATED ART

Decentralization is a common idea underlying both Digital Cryptocurrency and Distributed Electricity Generation using DERs and ESS. Bitcoin and Ethereum are today's well known digital cryptocurrencies [1,2] while renewable energy resources (including Solar, Wind, Hydro, Bio, Geothermal, Waste) and Clean energy resources (Natural gas) are considered as DERs for electricity generation [3]. Another commonality is that both require electron movement. Because of these common characteristics, there have been many efforts to combine these two activities into one. The ultimate goal of these activities is to establish virtual electricity trading as a form of digital cryptocurrency. Some promising proposals include Power Ledger, Grid+, and WePower. However, none of these proposals provide a solution sufficient for realizing potential synergies between digital cryptocurrency and virtual electricity trading, because of the complexities of the traditional electricity industry (mainly composed of generation, transmission and distribution systems). Power Ledger proposes a partial solution based on peer-to-peer virtual electricity trading at a limited scale under a semi-regulated environment [4]; Grid+ makes hardware to manage virtual electricity transactions together with Blockchain technology without a clear path for authorization from electric power utilities and authorities [5]; WePower suggests raising a lower cost capital for the construction of Solar projects and virtual electricity trading in a traditional wholesale electricity market without a clear strategy to be a qualified electricity wholesaler [6]. Finally, all of these solutions require a prepayment for future electricity consumption and/or trading compared to the current real world system which asks for payment in arrears for actual electricity consumption as recorded by a meter, through a monthly bill.

Stability and Security in the electricity industry are extremely crucial in providing customers with uninterrupted and stable electricity. To achieve these goals, the electricity industry has established a great deal of strict regulation. However, the industry is currently facing huge challenges in their transmission and distribution systems for the integration of rapidly growing capacity of electricity generation using DG plants in addition to traditional electricity generation plants. Tens of billions of dollars of investment for upgrading current transmission and distribution infrastructure is required for a state level solution in the United States. Due to more imminent issues of upgrading and securing aging infrastructure, there may be less capacity for the electricity industry to consider virtual electricity trading. But increasing efforts for integration of DG plants into grid networks would eventually provide better opportunities for virtual electricity trading. This improvement will make virtual and real-time data collection and transfer, through Internet of Things (IoT) technology and Information Communication Technology (ICT), more easily available which is essential infrastructure for virtual electricity trading.

Bitcoin and Ethereum are today's well known digital cryptocurrencies based on Blockchain technology. Bitcoin is the first decentralized digital cryptocurrency designed for a worldwide payment system and works without a central repository or single administrator. The network is peer-to-peer and transactions take place between users directly using cryptography, without an intermediary. These transactions are verified by network nodes and recorded in a public distributed ledger called a Blockchain. Bitcoin was invented in 2009 and Cambridge University estimates that in 2017, there are 2.9 to 5.8 million unique users. The main advantages of Bitcoin are unlike gold, fiat currencies, easy to transfer; easy to secure; easy to verify; easy to granulate; not controlled by a central authority; not debt-based; potentially anonymous; freeze-proof; faster to transfer; no taxes; cheaper to transfer. Bitcoin continues its unprecedented rise, seeing a large influx of buy volume. However, Bitcoin's major downsides are the absence of tangible intrinsic value, escrowing money deposit, and mean of money laundering. First, Bitcoin has properties resulting from the system's design that allows them to be subjectively valued by individuals. But, it doesn't have historically intrinsic value, as well as other attributes like divisibility, fungibility, scarcity, and durability, helped establish certain commodities as mediums of exchange. Second, Bitcoin has no built-in chargeback mechanism. Its base-layer transactions are final and irreversible by design. The most practical way of consumer protection is multiset escrow as essential protection. This needs deposit of money at an account at a trading company which may not be trustworthy or legitimate. Third, the use of bitcoin is recognized to be widespread in criminal activity including terrorism, drug-dealing and public corruption, with its growth considered by many to be linked to a rise in international crime [1]. Virtual electricity trading platform, Eleutheria—the team is proposing—may be able to resolve issues such as intrinsic value and built-in-charge back because it is based on electricity which has intrinsic value and tangible assets of electricity generation plants.

Ethereum is an open-source, public, Blockchain-based distributed computing platform featuring “Smart Contract” functionality based on Blockchain technology. A digital protocol that automatically executes predefined processes of a transaction without requiring the involvement of a third party. It provides a decentralized virtual machine, the Ethereum Virtual Machine (EVM), which can execute scripts using an international network of public nodes. Ethereum also provides a cryptocurrency token called “ether”, which can be transferred between accounts and used to compensate participant nodes for computations performed. “Gas”, an internal transaction pricing mechanism, is used to mitigate spam and allocate resources on the network. Ethereum was proposed in late 2013 and acts as a platform for other products and services, allowing for a robust ecosystem to grow around the system [2]. Most sizeable DG plants have long term (usually longer than 20 years) Power Purchase Agreement (PPA) from reliable off-takers which can be processed as a smart contract of Ethereum. Therefore, Ethereum is providing strong basis for Eleutheria. Eventually, future of Eleutheria may be more promising than Bitcoin and Ethereum.

### SUMMARY

This invention discusses a new digital cryptocurrency named Eleutheria throughout this patent that can be used within a virtual electricity trading platform to virtually transact real and digital currencies, smart contracts, financial derivatives, and electricity based on DG plants using DERs and ESS by exploiting new technologies within IoT, ICT, AI, and Smart Grid. Using concepts and technologies established for Bitcoin and Ethereum, Eleutheria can be used for more than just currency. One of them is a form of currency exchange among different foreign currencies without prepayment based on international DG plants. The other is virtual trading of real time and/or future electricity. In an off-grid network using DG plants, it is possible to trade electricity without any restriction from utilities and authorities. A customer and/or prosumer can virtually trade electricity as a form of credit using

Eleutheria. Since the size of an off-grid network is limited to a few residential houses and association/commons, buildings, or a micro-grid, under current distribution and transmission infrastructure, the application scope of Eleutheria would be geographically confined to a small group of people. However, this boundary can be further expanded with proper engagement from utilities and authorities. One promising solution will be to combine the concepts of community solar and virtual electricity trading. There has been recent progress in easing regulation to allow for community solar projects from utilities and authorities such as in the state of Illinois, USA [10]. For easier decision-making for an investment, community solar projects are now allowed to build anywhere within a service territory of the utility which will facilitate the integration to a grid network, and to redeem a generated electricity on his/her monthly bill as a credit proportional to a subscribed amount. However, this electricity credit is not allowed to trade with the others in a service territory of another utility. Therefore, if virtual trading of credits were allowed, the boundary of Eleutheria can be broadened to the state level in the United States. Further, if Eleutheria administration has some control capacity of distribution facility, they could better facilitate virtual electricity trading. As numbers and locations of distribution facilities controlled by Eleutheria participants increase, the possibility of worldwide application of Eleutheria will exponentially grow.

In this platform, four basic and two derivative cryptocurrencies with a value distinction for a waiting period of a designated transaction will be issued to achieve the following goals:
ψ₁(k,t): Cryptocurrency to transact “Currency Exchange” in a designated country and time
ψ₂(k,t): Cryptocurrency to transact “Smart Contract” in a designated country and time
ψ₃(k,t): Cryptocurrency to transact “Financial Derivatives” in a designated country and time
ψ₄(k,t): Cryptocurrency to transact “Electricity” in a designated country and time
ψ_{own}(k,t): Cryptocurrency to transact “Ownership of DG plants” in a designated country and time
ψₑₗₑᵤₜₕₑᵣᵢₐ(k,t): Cryptocurrency, Eleutheria represents a portfolio of cryptocurrencies, ψᵢ owned by a participant

where k: Geographic coordinate of a designated DERs project location
t: Remaining time to a designated transaction=t_{f}−tₒ
t_{f}: Designated transaction time in the future
tₒ: Present
i==1, 2, 3, 4, and own
   The portfolio of each cryptocurrency can be represented as Eleutheria—ψₑₗₑᵤₜₕₑᵣᵢₐ, which will be calculated and guided to avoid any arbitrage by Eleutheria administration, as below:

ψₑₗₑᵤₜₕₑᵣᵢₐ(k,t)=ψ₀+Σβᵢ(k,t)×χᵢ(k,t)×ψᵢ(k,t)

where ψ₀: Present value of USD in USA
βᵢ(k,t): Percentage of ψᵢ in a portfolio
χᵢ(k,t): Correlation coefficient between Eleutheria and each currency
i=1, 2, 3, 4, and own
   The ownership of capital assets always contains related risks and needs a risk premium to compensate any risk. In Eleutheria, the risk premium can be expressed as below:

$$\begin{matrix}{f}_{i} ( R \text{:} k , t ) = Risks involved in Risk Matrix of \\ Eleutheria - Risk Free Return \\ = {α}_{i} ( k , t ) \times {f}_{i} ( S \text{:} k , t ) \times {f}_{i} ( P \text{:} k , t ) \times {f}_{i} ( D \text{:} k , t ) - {f}_{o} ( k , t )\end{matrix}$$

where fᵢ(R:k,t): Risk presume factor due to Risks involved in each currency of Eleutheria
αᵢ(k,t): Correlation coefficient of Risk Premium from peer-to-peer trading
fᵢ(S:k,t): Degree of Severity from each risk
fᵢ(P:k,t): Probability of Occurrence of each risk
fᵢ(D:k,t): Detection capability of each risk
fₒ(k,t): Risk free return factor
   Table 2 in this invention is Risk Matrix of Eleutheria
      Then, value of each cryptocurrency can be expressed as below:

ψ₁(k,t)=ψ₀[1+fᵢ(R:k,t)]

In developed markets, sizeable DG plants and/or aggregation of any DG plants from solar homes to micro grids owned by Eleutheria administration within a utility's territory can provide a solution for a peak demand. As an exchange, Eleutheria can have a long term (longer than 1 year) fixed electricity price/credit block from the utility. Then, the fixed price electricity block can be sold to an electricity wholesale market, an Eleutheria participant, and/or individual as demanded. If a utility allows Eleutheria to control one of its own distribution systems at a proper fee, trading of electricity-ψ₄(k,t) cryptocurrency would be easier. Major amounts of electricity supply can be supplied from DG plants inside the distribution system under the control of Eleutheria and the remaining demand can be provided from the utility. The necessary capital for the portfolio can be raised by ψ_{own} cryptocurrency and payback method are Share ITC (Income Tac Credit), REC (Renewable Energy Credit), SREC (Solar-REC), MARCS (Modified Accelerated Recory of Cost System), Electricity Bill Saving, PPA, Electricity Wholesale etc. A control capability of a transmission system with a proper fee would also provide a better solution for trading of ψ₄(k,t) cryptocurrency.

### BRIEF DESCRIPTION OF THE DRAWINGS

The appended drawings illustrate the method and system of the invention, although it will be understood that such drawings depict preferred embodiments of the invention. Therefore, these are not to be considered as limiting its scope with regard to other embodiments which the invention is capable of contemplating. Accordingly:

FIG. 1 is a schematic illustration of the present invention, virtual electricity trading platform, Eleutheria.

FIG. 2 is a schematic illustration of an application of Eleutheria to inland fish farms.

Table 1 is the category of DG plants portfolio

Table 2 is the risk assessment matrix of Eleutheria

### DETAILED DESCRIPTION

As discussed in description of the related art of the invention, current proposals cannot provide a solution sufficient to realize potential synergies from digital cryptocurrency and virtual electricity trading, given the complexities of the traditional electricity industry mainly composed of generation, transmission and distribution systems. All of these solutions require a prepayment for future electricity consumption and/or trading compared to the current real world system which asks for payment in arrears for actual electricity consumption as recorded by a meter, through a monthly bill. The launch of a digital cryptocurrency for virtual electricity trading by exploiting technologies including IoT, ICT, AI, Smart Grids, ESS and DG plants may provide a first step in decentralization of the electricity industry. With proper collaboration from utilities and authorities, this can deliver a great value to its consumers.

Bitcoin and Ethereum can provide a mechanism for trading and transacting of digital currency, smart contracts, and any financial derivatives based on these two as discussed in DESCRIPTION OF THE RELATED ART. However, Eleutheria can add more value by using concepts and technologies established for Bitcoin and Ethereum. One value-add is the ability to exchange among different currencies without serious legal concerns based on international DG plants. A tariff (a payment for kWh of electricity generation) is usually paid with a certain country's currency where a DG plant is located. For example, tariffs will be paid by Rupee if a DG plant is in India; Euro in EU; Yuan in China; Brazilian Real in Brazil etc. A participant of Eleutheria and owner of DG plant in India can arrange automatic collection of the tariff and deposit it into designated bank accounts in real time using IoT, ICT and Al technologies. Then, a US customer, who wants to send money to his/her Indian relative, can purchase Eleutheria with USD and the relative can have an equivalent value of Rupee deposited in their designated bank accounts at the same time. It is not necessary to deposit cash in advance as compared to current digital cryptocurrencies. This type of transaction can be applied to worldwide DG plants and currencies. As utility scale DG plants become more ubiquitous, Eleutheria will have the ability to be more widely used in transactions all over the world. In addition, since a utility scale DG plants has PPA from a reliable off-taker of electricity generation with a scheduled tariff for longer than 20 years, a currency exchange can also be arranged for a future event as a smart contract. Financial derivatives would also be applicable. The other is trading of virtual real time and/or future electricity. In an off-grid network using DG plants, it is possible to trade electricity without any restriction from utilities and authorities. A customer and/or prosumer [8] can virtually trade electricity as a form of credit using Eleutheria. Since the size of an off-grid is limited to a few residential houses and association/commons, buildings, or a micro-grid at maximum under current distribution and transmission infrastructure, the application scope of Eleutheria would be geographically confined to a small group of people. This boundary can be expanded with proper collaboration from utilities and authorities. One promising solution is a combined idea of community solar and virtual electricity trading. A community solar project is referred to as both ‘community-owned’ projects as well as third party-owned plants and its electricity is shared by more than one consumer [9]. There has been recent progress in easing regulation to allow for community solar projects from utilities and authorities such as in the state of Illinois, USA [10]. For easier decision-making for an investment, in community solar projects are now allowed to build anywhere within a service territory of the utility which will facilitate the integration to a grid network, and to redeem a generated electricity on his/her monthly bill as a credit proportional to a subscribed amount. However, this electricity credit is not allowed to trade with the others in a service territory of another utility. Therefore, if virtual trading of credits were allowed, the boundary of Eleutheria can be broadened to the state level in the United States. Further, if Eleutheria administration has some control capacity of distribution facility, they could better facilitate virtual electricity trading. As numbers and locations of distribution facilities controlled by Eleutheria participants increase, the possibility of worldwide application of Eleutheria will exponentially grow. There remains an issue to accommodate the value difference in Levelized Cost Of Energy (LCOE) among DG plants depending on locations and countries.

The global electricity industry generates about 23 trillion kilowatt hours (kWh). Companies in the industry generate, transmit, and distribute electric power. Major companies are Duke Energy, Exelon, and Southern Company (all based in the US), as well as EON (Germany), EDF (France), Enel (Italy), and Tokyo Electric Power (Japan). And the global electric market will reach $2.2 trillion in 2017 [7]. Although deregulation has altered the electricity power markets in many nations, electric utilities often continue to operate as unofficial monopolies in a given service territory. Government regulations and fuel costs usually determine profitability; Large utility companies have an advantage in negotiating fuel contracts and interpreting regulations. It is a highly centralized, secretively closed, excessively regulated industry and opened for only a few major players. Millions of customers use electricity from a small number of large utility companies; majority of electricity is almost secretively traded between utilities and licensed traders; it is almost impossible for new players to enter major global electricity markets because of the complexity of regulations and cost structures; and any saved value contributed from customers is not shared with them, but mainly belongs to the utilities. Successful penetration of DG plants into a grid network and the electricity industry is a crucial key for future success of Eleutheria. A DG plant typically faces major regulatory challenges for integration to a grid network as below:

Complicated, numerous, and time-consuming project permit procedures depending on authorities

Service Territories of Utilities, RTOs, and Wholesale Electricity Markets

Interconnection Permission

Transmission Grid Capacity

Allocation into Utilities' Annual Power Procurement Plan

Demand Response: Annual-Daily, Seasonal-Hourly, Days-Hourly, Hours-Seconds Basis Plans

Point Of Interconnection (POI) location and distance

Power Quality (V, ΔV, Δf, Reactive Power, etc) & Safety

Licenses Requirement

O&M Coordination with Utility

It is difficult to integrate a DG plant into a grid network to overcome these issues. As capacity of a DG plant becomes larger, integration becomes more difficult. However, recent legislative achievements ensure a bright future for DG plants: a number of states have mandates or goals to make utilities prepared to be 30-50% renewables and even beyond 50% in some states within the United States [11]. For example, California and New York have enacted a mandate for 50% of power be fulfilled by renewables by 2030; the goal for Hawaii is to be 100% renewable by 2045. San Diego Gas & Electric (SDG&E) recently filed a rate case asking for approval of $2.2 billion for system upgrades, including improvements needed to increase integration of DG plants; Southern California Edison (SCE) for $2.1 billion; Pacific Gas & Electric's (PG&E) for $1.15 billion; PJM for $13.7 billion to accommodate up to 30% renewables. The CAISO started to collect a $13.83/MWh Transmission Access Charge (TAC) to pay for needed transmission upgrades by 2023. Based on the actives of utilities and authorities, the following types of impacts associated with integrating large amounts of DG plants into US wholesale electricity market will be expected [11]:
Transmission and interconnection investment associated with getting new supply to areas of use;
Transmission and distribution investment related to greater output variability, production vs. load differences, need for more ancillary services and increased ability to manage over-generation conditions;
Existing generation investment or retirement to address more extreme ramping, more frequent starts and stops and cycling;
Increased forecasting, system monitoring and system controls;
At the distribution level, increasing numbers of DG plants present a host of issues-unidirectional and predictable flow vs. many sources at varying times of day and in different directions;
But, there are benefits from DG plants. These can provide the distribution grid with Distribution capacity, Voltage regulation, VAR support, Grid back-tie, and Resiliency services via microgrids.

The response from utilities and authorities on these issues can be reactive or proactive depending on their current situation position. However, if a portion of required funds for updating infrastructure in transmission and distribution system can be raised by Eleutheria, it may be easier for them to execute improvements to integrate DG plants into grid networks.

Virtual trading of real/digital currencies, smart contracts, financial derivatives, and electricity is the main goal of Eleutheria (a digital cryptocurrency for virtual electricity trading platform) based on electricity generation using DG plants as addressed in the previous section. As opposed to Bitcoin, it will have intrinsic value and built-in charge back; it can incorporate Power Purchase Agreement (PPA) into smart contracts similar to Ethereum. Eleutheria's potential to succeed and be more valuable may be more promising than Bitcoin and Ethereum. Therefore, the answers to the following questions are crucial to design a careful strategy for the successful deployment of Eleutheria. The addressed topics, questions and opportunities were carefully reviewed and incorporated into the strategy. Given the complexities of building a world-wide network, it will require a step-by-step approach starting from local regions.

a) Virtual exchange of real/digital currencies, smart contracts, and financial derivatives based on electricity generation and its tariff from worldwide DG plants owned by Eleutheria administration.
What are the regulatory challenges from governments and financial industry for Eleutheria and how can those challenges be solved?
How would the initial and future value of Eleutheria be determined?
What would be optimum size of DG plant for Eleutheria?
How can different LCOE and PPA of DG plants be facilitated?
Can Eleutheria be used as capital to fund deployments of worldwide DG plants? Will its value be recognized considering a waiting period before the collection of a tariff based on the construction status of DG plants?
How can concepts of currency exchange and ownership of DG plants be incorporated into Eleutheria?
What software and hardware will be required for Eleutheria?
   b) Virtual real-time and future electricity trading in an off-grid network using DG plants
Would utilities and authorities challenge use of Eleutheria?
What would be optimum size of off-grid networks for Eleutheria?
Can Eleutheria be used as capital to fund deployments of worldwide off-grid DG plants?
How can concepts of currency exchange and ownership of off-grid DG plants be incorporated into Eleutheria?
What software and hardware will be required for Eleutheria?
   c) Electricity generation credits from community solar (DG plants) for Eleutheria
What support will be necessary from utilities and authorities for virtual trading of electricity generation credits from a community solar (DG plants) projects?
What would be optimum size of community solar (DG plants) for Eleutheria?
Can Eleutheria be used as capital to fund deployment of worldwide community solar/DG plants?
How can concepts of currency exchange and ownership of community solar/DG plants be incorporated into Eleutheria?
What software and hardware will be required for Eleutheria?
   d) Distribution systems of electricity controlled by Eleutheria administration
What regulatory conditions are required to control distribution systems of electricity by Eleutheria?
What would be optimum size of distribution systems for Eleutheria?
What software and hardware will be required for Eleutheria?
   e) Legislative mandates for utilities to be at 30˜50% DG plants in states, USA and efforts for updating infrastructure in transmission and distribution system
How can Eleutheria take advantage of these recent legislative mandates?
Can Eleutheria be used as capital to fund infrastructure updates?
Can Eleutheria have partial ownership and/or controllability on a portion of Transmission system by providing funds for the improvement and/or paying a necessary fee?

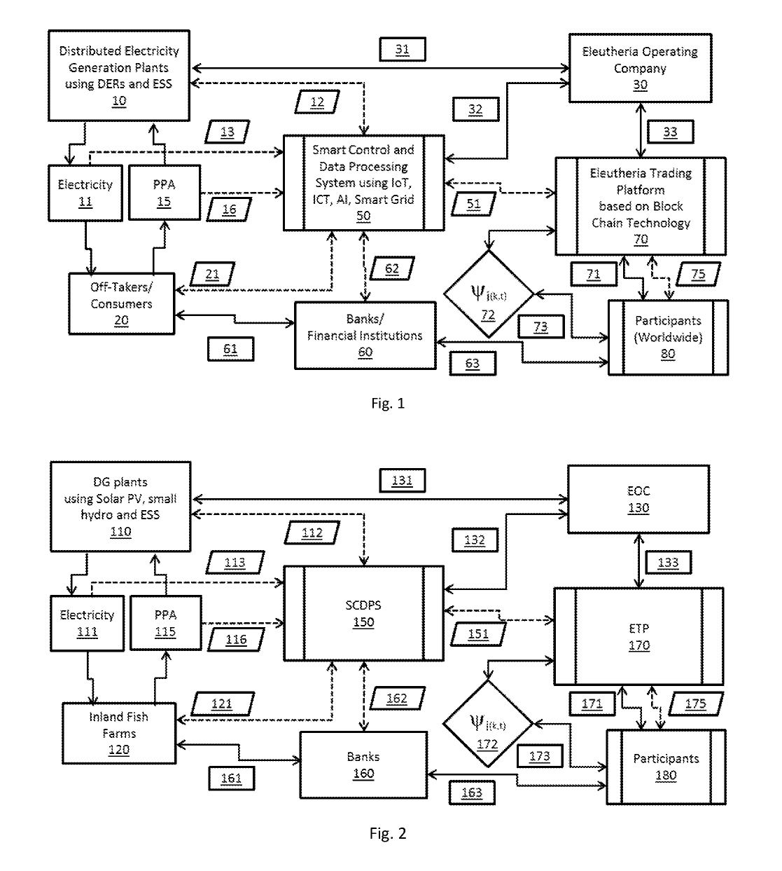

The operations and transaction flows of Eleutheria is illustrated in FIG. 1. Solid arrows represent transaction flow and dashed arrows indicate data flow. One-headed and doubled-headed arrows indicate either one or two way transactions. The electricity (11) generated from DG Plants using DERs and ESS (10) is delivered to off-takers/consumers (20) based on PPA 15 as well as spot customers. The PPA is a long term (more than 1 year) electricity power purchase agreement contract between off-takers/consumers and owners of DG Plants, Eleutheria Operating Company (EOC) (30). Since the designated tariff per generated electricity (typically kWh) is automatically billed and paid at a given period (typically monthly), PPA would be considered as a smart contract. DG Plants are also controlled, operated and maintained by the EOC (31). During generation, transmission, distribution, and consumption of electricity from DG plants, the real-time data of electricity generation (12), electricity consumption (13), and execution of PPA (16) are transmitted to Smart Control and Data Processing System (SCDPS) (50) using IoT, ICT, Al, and smart grids. SCDPS is controlled, operated, and maintained by the EOC (32). On a designated date, off-takers/consumers pay the electricity bill to a designated account at a designated bank or financial institutions (60) with cash (currency) and/or equivalent valuables (61). Then real-time data of tariff payment (21) and financial transactions (62) are transmitted to SCDPS. All real-time data of SCDPS (51) are shared with Eleutheria Trading Platform (ETP) (70) which is controlled, operated, and maintained by the EOC (33). ETP provides trading and transaction platform for crypto currency-Eleutheria, real currencies, smart contracts, electricity, financial derivatives, and ownership of DG plants (71). A real-time reference value of each item (72) is provided to worldwide ETP participant (80) based on real-time data from SCDPS (73) as discussed follow. Real-time market value and transaction information are also provided to participant by ETP (75). Participants use designated banks and financial institutions for transfer of cash and/or equivalent valuables (63).

As discussed, the main goal of Eleutheria is to establish a digital cryptocurrency trading platform which can virtually transact real/digital currencies, smart contracts, financial derivatives, and electricity based on electricity generation using DG plants. In this platform, four basic and two derivative cryptocurrencies with a value distinction for a waiting period of a designated transaction will be issued to achieve the goal as below:
ψ₁(k,t): Cryptocurrency to transact “Currency Exchange” in a designed country and time
ψ₂(k,t): Cryptocurrency to transact “Smart Contract” in a designed country and time
ψ₃(k,t): Cryptocurrency to transact “Financial Derivatives” in a designed country and time
ψ₄(k,t): Cryptocurrency to transact “Electricity” in a designed country and time
ψ_{own}(k,t): Cryptocurrency to transact “Ownership of DG plants” in a designed country and time
ψₑₗₑᵤₜₕₑᵣᵢₐ(k,t): Cryptocurrency, Eleutheria represents a portfolio of cryptocurrencies, ψᵢ owned by a participant

where k: Geographic coordinate of a designated DERs project location
t: Remaining time to a designated transaction=t_{f}−tₒ
t_{f}: Designated transaction time in a future
tₒ: Present
i=1, 2, 3, 4, and own

Since Eleutheria is based on electricity generation from DG plants, it will be necessary for Eleutheria administration to secure, build, and own valuable DG plants during the beginning stages of the platform; ownership can be shared with other parties as the boundary of Eleutheria expands. The required investment capital for DG plants for Eleutheria will be initially raised through a cryptocurrency, ψ_{own}(0), for ownership of DG plants and related utility infrastructure as summarized in table 1. An initial percentage and value of ownership will be proposed and determined by Eleutheria administration based on risks assessed financial modeling including required investment and raised fund for initial DG plants. Then, ψ_{own}(k,t) value will be traded in peer-to-peer transactions similar to other cryptocurrencies. Any operational and developing DG plants owned by other parties/individuals can join the Eleutheria platform after stabilization of the Eleutheria trading platform.

The portfolio of DG plants in Eleutheria can be mainly categorized by capacity of DG plants in emerging and developed market as summarized in table 1. In emerging markets, solar homes, solar on building roofs and premises, community systems, off-grid villages, and micro grids (commonly recognized terminology) are main targets for DG plants of Eleutheria. Typical capacity and its applications can describe a potential user. The necessary funding to build a system will be raised by issuing ψ_{own}(0) cryptocurrency with a payback on the investment except a donation which will be collected by the leasing agreement and PPA. Specially, a donation for small capacity solar home is very crucial for rural electrification. This will benefit 1.2 billion people who cannot currently readily access electricity. The required fund will be covered by an additional (up to 0.01%) transaction fee of Eleutheria. A participant of Eleutheria is not only having a benefit for him/herself, but also helping people. Energy storage systems can be added after considering the technological and financial conditions of a DG plant.

In developed markets, there are additional portfolios such as utility scale system, long term pricing, and engagement on a distribution system of utility in addition to those of emerging markets. Utility scale DG plants are targeting to replace retiring traditional coal power plants or small size nuclear power plants. The long term pricing business model is based on yearly increasing electricity prices of utilities every year and a peak demand of a day. It is well acknowledged that electricity generation costs from a traditional coal power plant will be continuously increasing due to environmental pollution and growing coal mining cost. Electricity price during a peak hour, usually ˜4-6 hours during a day, is higher because extra electricity generation capacity is usually installed only to fulfill peak hour operations instead of 24 hour operation in the case of based load capacity. DG plants can solve these issues. Since electricity generation hour of solar project is specially well matched with a typical peak demand time, it can cover peak demand at a competitive cost. DG plants can be free from the issues of environmental pollution and resources' cost. Therefore, sizeable DG plants and/or aggregation of any DG plant from solar home to micro grid owned by Eleutheria administration in a utility's territory can provide a solution for peak demand. As an exchange, Eleutheria can have a long term (longer than 1 year) fixed electricity price/credit block from the utility. Then, the fixed price electricity block can be sold to electricity wholesale market, Eleutheria participant, and individual as demanded. If a utility allows Eleutheria to control one of its own distribution system at a proper fee, trading of electricity-ψ₄(k,t) cryptocurrency would be easier. Major amounts of electricity supply can be supplied from DG plants inside the distribution system under the control of Eleutheria and the remaining demand can be provided from the utility. The necessary capital for the portfolio can be raised by ψ_{own} cryptocurrency and payback method are Share ITC, REC, SREC, MARCS, Electricity Bill Saving, PPA, Electricity Wholesale etc. A control capability of a transmission system with a proper fee would also provide a better solution for trading of ψ₄(k,t) cryptocurrency.

Once DG plants in Eleutheria are ready for commercial operation for electricity generation, four basic cryptocurrencies, ψ₁, ψ₂, ψ₃, and ψ₄ can be traded. Currency Exchange (ψ₁ cryptocurrency) for present/future will be transacted between a real-time/future tariff for electricity generation and cash. A tariff (payment for kWh of electricity generation) is usually paid with a specific country's currency where the DERs project is located as discussed in section 3. If a participant of Eleutheria wishes to exchange between currencies where DG plants are located, it can be arranged using an automatic collection of tariff and deposited into designated bank accounts in real time with help of IoT and Al. For example, a US participant, who wants to send money his/her Indian relative, can purchase ψ₁(0) cryptocurrency at Eleutheria with USD and a relative can have the equivalent value of Rupee deposited into their designated bank accounts by using ψ₁(0) cryptocurrency from his/her US relative at the same time. It is not necessary to deposit cash in advance as opposed to current digital cryptocurrencies. This type of transaction can be applied to among worldwide DG plants in many countries. As utility scale DG plants become more ubiquitous, Eleutheria will have the ability to be more widely used in transactions all over the world. The main basis of smart contract (ψ₂ cryptocurrency) at the launching stage is the PPA with a scheduled tariff for longer than 20 years between a reliable off-taker of electricity and Eleutheria administration. The contract will contain a term regarding monthly collections of a tariff as usual and will guarantee the steady cash flow from a tariff. As a simple example, a participant can reserve a future currency exchange (ψ₁(k,t) cryptocurrency) and Eleutheria can arrange the transaction based on an estimated collection schedule and amount of tariff. Once the platform is stabilized, the basis for a smart contract can be expanded to any terms in the PPA and any contracts related with DG plants. Although a future price option for Eleutheria will be the starting basis for financial derivatives (ψ₃ cryptocurrency), more items can be developed subsequently.

Electricity (ψ₄ cryptocurrency) is presently the most complicated and geographically limited cryptocurrency to trade in Eleutheria because electricity transmission and distribution are controlled by utilities and authorities. The smaller the capacity of a DG plant, the harder it is to trade electricity (ψ₄ cryptocurrency). As mentioned previously, aggregation and block sale of electricity generation from any DG plants owned by Eleutheria with permission from utilities and authorities is a better solution than separate trading of electricity from each DG plants. The size and level of aggregation of DG plants capacity would be discussed and determined with the support from utilities and authorities. If Eleutheria has the control capability for the distribution and transmission system with a proper fee, geographical and regulatory limits of ψ₄ cryptocurrency can be lifted. As Eleutheria gains more control capability of distribution and transmission systems in various countries, Eleutheria transactions can occur more widely across the globe.

The portfolio of each cryptocurrency can be represented as Eleutheria-ψₑₗₑᵤₜₕₑᵣᵢₐ, which will be calculated and guided to avoid any arbitrage by Eleutheria administration, as below:

ψₑₗₑᵤₜₕₑᵣᵢₐ(k,t)=ψ₀+Σβᵢ(k,t)×χᵢ(k,t)×ψᵢ(k,t)

where ψₒ: Present value of USD in USA
βᵢ(k,t): Percentage of ψᵢ in a portfolio
χᵢ(k,t): Correlation coefficient between Eleutheria and each currency
i=1, 2, 3, 4, and ownership

The ownership of capital assets always contains risks related with them and needs a risk premium to compensate any risk. In Eleutheria, the risk premium can be expressed as below:

$$\begin{matrix}{f}_{i} ( R \text{:} k , t ) = Risk involved in Eleutheria - Risk Free Return \\ = {α}_{i} ( k , t ) \times {f}_{i} ( S \text{:} k , t ) \times {f}_{i} ( P \text{:} k , t ) \times {f}_{i} ( D \text{:} k , t ) - {f}_{o} ( k , t )\end{matrix}$$

where fᵢ(R:k,t): Risk presume factor due to Risks involved in each currency of Eleutheria
αᵢ(k,t): Correlation coefficient of Risk Premium from peer-to-peer trading
fᵢ(S:k,t): Degree of Severity from each risk
fᵢ(P:k,t): Probability of Occurrence of each risk
fᵢ(D:k,t): Detection capability of each risk
fₒ(k,t): Risk free return factor
   Then, value of each cryptocurrency can be expressed as below:

ψᵢ(k,t)=ψ₀[1+fᵢ(R:k,t)]

Risks in Eleutheria can be primarily categorized into four major level 1 categories such as financial, governmental, regulatory, and utility as listed in table 2. And each level 1 risk has sublevel risks-level 2. The correlation between level 2 and each cryptocurrency, fᵢ(R:k,t) will be quantified with collected data.

The first stage of the roadmap is for Eleutheria to pilot with international community and sizable scale DG plants. The required capital for construction of DG plants will be raised by ψ_{own}(0) cryptocurrency. Trading of ψ₁, ψ₂, and ψ₃ will begin as commercial operations of DG plants are getting ready. But, ψ₄ cryptocurrency trading will be geographically limited during the beginning stages of Eleutheria because the missing control capability on the distribution and transmission system. In the second stage, to solve this issue, Eleutheria will arrange for control capability with utility and authority in a small city and/or in an island in a designated country. Then, it can be expanded into more cities and islands in many countries.

Another important mission of Eleutheria is rural electrification for 1.2 billion people who are deprived of access to electricity. The necessary funds for rural electrification will be covered through an extra transaction fee of Eleutheria. It can be up to 0.01% of transaction fee. Considering the fact that a typical transaction fee for currency exchange by a bank is ˜5% of the total exchange amount, it is a relatively miniscule cost, and yet, it will provide precious electricity to people who cannot access and afford to have it.

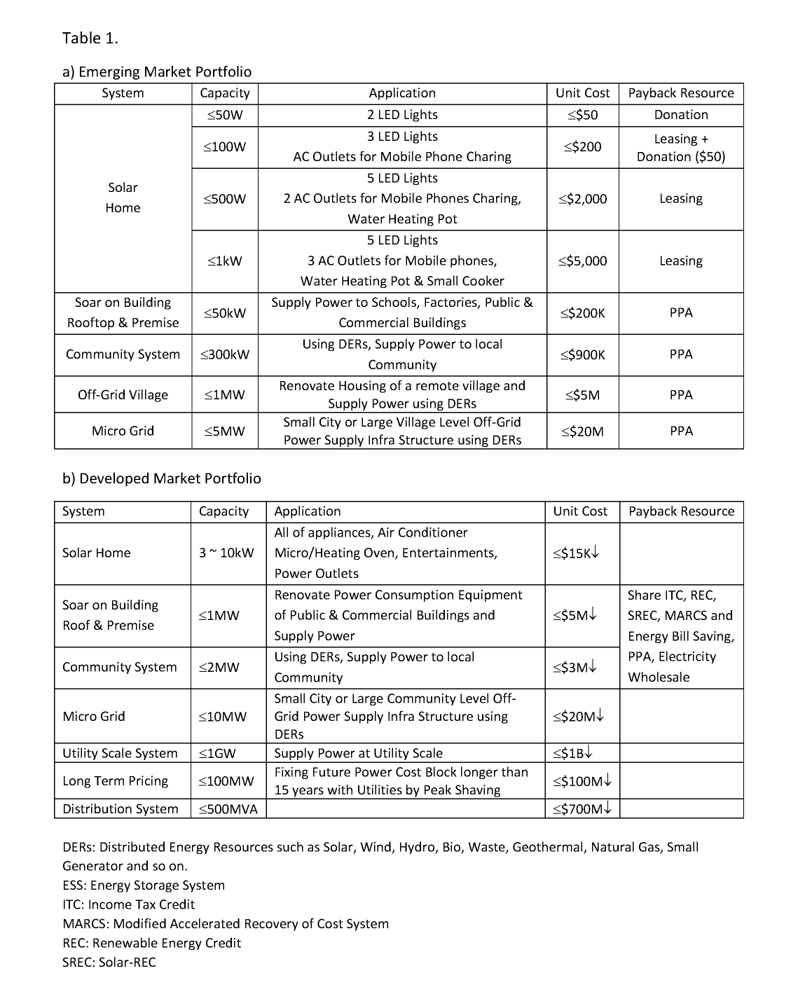

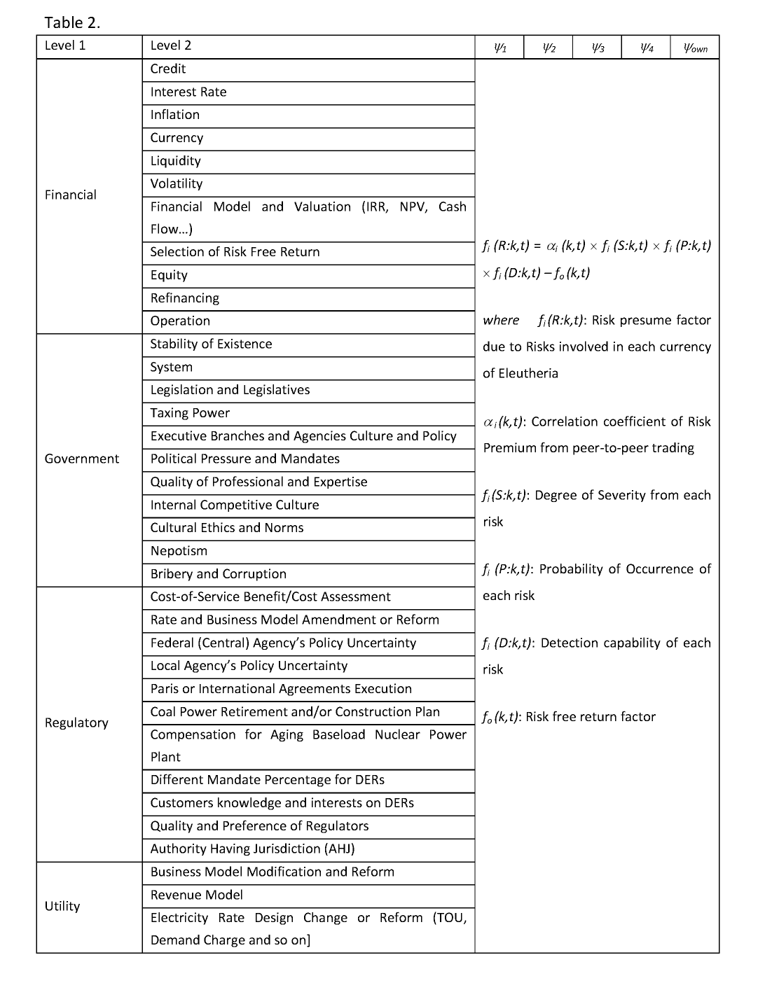

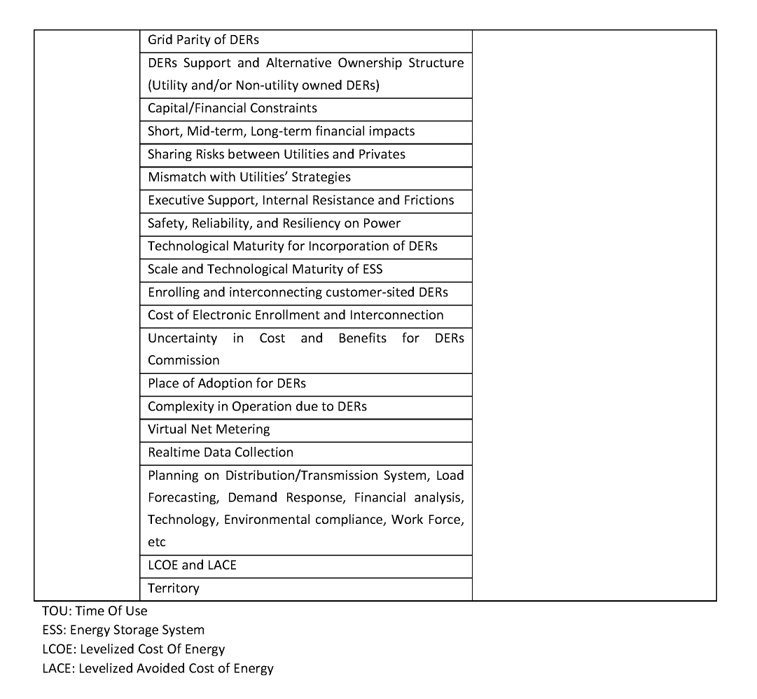

A specific Example is explained in FIG. 2. In a big island with the area of 1,848 km² (714 sq. mi) in Korea, there are more than 350 inland fish farms. An average size of each fish farm is about 5,000 sq. m (˜1.2 acre). Sea water pumping from costal area is used for fish farming and continuously refreshed 24 hours a day for 365 days a year. Average power consumption for a farm is ˜260 MWh/month and ˜3,120 MWh/year which is equivalent to the power consumption of ˜300 typical US houses. Major power demands are from 6 (Six) water pumps, 2 (two) freezer rooms, and a worker's dormitory. Since ˜45% of electricity demand of the island is covered by electricity supplied from main land through underwater electricity power cable, the supply of electricity in the island has not been able to match the demand recently. Electricity independence of the island from the main land has been becoming an urgent issue. The imminent potential risk of an increase in electricity cost would be specially fatal to the heavy electricity consuming fish farm business. Under current issues of electricity supply and cost, the owners association of inland fish farms is looking for solutions to overcome this imminent risk. Therefore, electricity generation by DG plants inside fish farms would be a novel solution which can secure the supply and cost of electricity.

A DG plant which is equipped with combination of 500 kWp Solar PV system and 100 kWp small hydro system with 50 kWh ESS can generate ˜2,000 MWh/yr inside an inland fish farm would cover two-third of its annual power consumption. At initial stage, EOC installs 50 (fifty) DG plants inside 50 (fifty) inland fish farms under PPA longer than for 20 years. As explained in FIG. 1, ETP can virtually trade electricity generated from DG plants, PPA, ownership of DG plants, cash revenue from sale of electricity to inland fish farm and REC of Korean utility company, financial derivative connected to these transaction as follow:

The electricity generated (111) from DG Plants inside the inland fish farm (110) is delivered to the inland fish farm (120) based on PPA, smart contract, (115) between inland fish farms and EOC (30). DG Plants are also controlled, operated and maintained by the EOC (131). During generation, transmission, distribution, and consumption of electricity, the real-time data of electricity generation (112), electricity consumption (113), and execution of PPA (116) are transmitted to SCDPS (150). SCDPS is controlled, operated, and maintained by the EOC (132). On a designated date, inland fish farms pay the electricity bill to a designated account at a designated bank or financial institution (160) with cash (currency) and/or equivalent valuables (161). Then real-time data of tariff payments (121) and financial transactions (162) are transmitted to SCDPS. All the real-time data of SCDPS (151) are shared with ETP (170) which is controlled, operated, and maintained by the EOC (133). ETP provides trading and transaction platform for crypto currency-Eleutheria, real currencies, smart contracts, electricity, financial derivatives, and ownership of DG plants (171). A reference value, on of each item (172) is provided to worldwide ETP participants (180) based on real-time data from SCDPS (173) as discussed. For a smooth implementation of Eleutheria, only members who invest USD $100+ into DG plants and personnel related to the inland fish farm business are qualified as participants during the initial operation stage of Eleutheria. Real-time market value and transaction information are also provided to participant by ETP (175). Participants use designated banks (160) for transactions of cash and/or equivalent valuable (163).

### REFERENCE

1. Wikipedia for Bitcoin
2. Wikipedia for Ethereum
3. Wikipedia for Distributed Energy Resources
4. Power Ledger, https://powerledger.io
5. Grid+, https://blog.gridplus.io
6. WePower, https://wepower.network
7. https://www.firstresearch.com/Industry-Research/Electric-Utilities.html
8. Wikipedia for Prosumer
9. Wikipedia for Community Solar
10. Illinois state future job act, 2016
11. http://www.tdworld.com/generation-and-renewables/are-we-ready-30-renewables-or-higher

What is claimed are:

1. A digital cryptocurrency for virtual electricity trading platform which can virtually transact real/digital currencies, smart contracts, financial derivatives, and electricity based on electricity generation.

2. The digital cryptocurrency of the claim is called but may not be limited to “Eleutheria” which means “freedom” in Greek.

3. The digital cryptocurrency of claim 1 is based on electricity which is generated mainly by Distributed Electricity Generation (DG) plants using Distributed Energy Resources (DERs) and Energy Storage Systems (ESS).

4. Data processing for a digital cryptocurrency of claim 1 can use (but is not limited to) technologies such as Internet of Things (IoT), Information Communication Technology (ICT), Artificial Intelligence (AI), and Smart Grids.

5. The digital cryptocurrency of claim 1 is composed of (but not limited to) four basic and two derivative cryptocurrencies:
ψ₁(k,t): Cryptocurrency to transact “Currency Exchange” in a designated country and time
ψ₂(k,t): Cryptocurrency to transact “Smart Contract” in a designated country and time
ψ₃(k,t): Cryptocurrency to transact “Financial Derivatives” in a designated country and time
ψ₄(k,t): Cryptocurrency to transact “Electricity” in a designated country and time
ψ_{own}(k,t): Cryptocurrency to transact “Ownership of DG plants” in a designated country and time
ψₑₗₑᵤₜₕₑᵣᵢₐ(k,t): Cryptocurrency, Eleutheria represents a portfolio of cryptocurrencies, ψᵢ owned by a participant
where k: Geographic coordinate of a designated DERs project location
t: Remaining time to a designated transaction=t_{f}−tₒ
t_{f}: Designated transaction time in a future
tₒ: Present
i=1, 2, 3, 4, and own

6. The digital cryptocurrency of claim 1 is the portfolio of each cryptocurrency defined in claim 5 which can be represented as Eleutheria-ψₑₗₑᵤₜₕₑᵣᵢₐ (but not limited to) as below:
ψₑₗₑᵤₜₕₑᵣᵢₐ(k,t)=ψ₀+Σβᵢ(k,t)×χᵢ(k,t)×ψᵢ(k,t)
where ψ₀: Present value of USD
βᵢ(k,t): Percentage of ψᵢ in a portfolio
χᵢ(k,t): Correlation coefficient between Eleutheria and each currency
i=1, 2, 3, 4, and own

7. Risk premium of a digital cryptocurrency of claim 1 can be expressed (but not limited to) as below:
$$\begin{matrix}{f}_{i} ( R \text{:} k , t ) = Risk matrix involved in Eleutheria - Risk Free Return \\ = {α}_{i} ( k , t ) \times {f}_{i} ( S \text{:} k , t ) \times {f}_{i} ( P \text{:} k , t ) \times {f}_{i} ( D \text{:} k , t ) - {f}_{o} ( k , t )\end{matrix}$$
where fᵢ(R:k,t): Risk presume factor due to Risks involved in each currency of Eleutheria
αᵢ(k,t): Correlation coefficient of Risk Premium from peer-to-peer trading
fᵢ(S:k,t): Degree of Severity from each risk
fᵢ(P:k,t): Probability of Occurrence of each risk
fᵢ(D:k,t): Detection capability of each risk
fₒ(k,t): Risk free return factor

8. Risks of claim 7 can be assessed qualitatively and quantitatively using a risk assessment matrix such as table 2 in this invention, but not limited to only such matrix.

9. The digital cryptocurrency of claim 5 assessed with risk premium can be expressed (but not limited to) as below:
ψᵢ(k,t)=ψ₀[1+fᵢ(R:k,t)]
where i=1, 2, 3, 4, and own

10. The digital cryptocurrency to transact “Electricity” of claim 5 use a method of getting a long term (longer than 1 years) fixed electricity price/credit block from the utility and selling it to electricity wholesale market, Eleutheria participant, and individual as demanded.

11. The method of claim 10 uses a sizeable DG plants and/or aggregation of any DG plant from solar home to micro grids within the service territory of a utility.

12. The digital cryptocurrency to transact “Electricity” of claim 5 uses a control capability of distribution systems within the service territories of utilities and authorities.

13. The digital cryptocurrency to transact “Electricity” of claim 5 uses a control capability of transmission systems within the service territories of utilities and authorities.

14. An additional transaction fee for the use of the digital cryptocurrency of claim 1 can be used to fund rural electrification for 1.2 billion people who currently cannot readily access and use electricity.
